(19) United States
(12) Patent Application Publication
(10) Pub. No.: US 2013/0325727 A1
(43) Pub. Date: Dec. 5, 2013

(54) SYSTEMS AND METHODS FOR DISPOSING NARCOTIC AND OTHER REGULATED WASTE

(71) Applicants: Mark MacDonell, Sugar Land, TX (US); Alan A. Davidner, Claremont, CA (US)

(72) Inventors: Mark MacDonell, Sugar Land, TX (US); Scott R. Mallett, Coto De Caza, CA (US); Alan A. Davidner, Claremont, CA (US)

(21) Appl. No.: 13/636,325

(22) PCT Filed: Mar. 21, 2011
(86) PCT No.: PCT/US11/29275

§ 371 Date: Mar. 1, 2013

Related U.S. Application Data
(60) Provisional application No. 61/317,143, filed on Mar. 24, 2010.

(51) Int. Cl. G06Q 10/00

(52) U.S. Cl. CPC G06Q 10/30
USPC 705/308

(57) ABSTRACT

A system for disposing of medical waste is generally configured to sort waste items into a plurality of containers according to applicable rules and regulations governing the handling and/or disposal of such items. In some embodiments, a system comprises sorting stations each of which houses a number of disposable containers. Each station can identify an item of waste, determine the most appropriate container for the item, and facilitate disposal of the item in the appropriate container. In some embodiments, a container or receptacle is configured to receive waste that comprises a controlled substance (e.g., a narcotic, other CII pharmaceutical waste, etc.). Such controlled waste can be discarded into the container or receptacle directly or indirectly (e.g., by placing the waste in a cup or other enclosure).

### CROSS REFERENCE TO RELATED APPLICATIONS

This application claims the priority benefit of U.S. Provisional Application No. 61/317,143, filed Mar. 24, 2010, the entirety of which is hereby incorporated by reference herein.

### BACKGROUND

1. Field

This application relates generally to the field of waste disposal systems, and in particular to a system for sorting controlled substances and other pharmaceutical waste for disposal.

2. Description of the Related Art

The Environmental Protection Agency (EPA) enforces the Resource Conservation & Recovery Act (RCRA) which was enacted in 1976 in order to control the disposal of harmful or hazardous waste materials. There are currently over 100,000 drugs commercially available in the United States, of which about 14,000 are considered hazardous by RCRA requirements. A typical medium size hospital utilizes thousands of different drugs in a year many of which are considered hazardous. The EPA is increasingly enforcing hospitals' compliance with the RCRA requirements because it has been shown in several studies that millions of pounds of pharmaceutical waste generated each year by hospitals and individuals is contributing to the pollution of groundwater and endocrine system damage in humans and other species. In addition, many organizations including Hospital for a Healthy Environment (H2E), Joint Council for Accreditation of Healthcare Organizations (JCAHO) and others are pressing hospitals to be more environmentally friendly. In view of these changes, hospitals are increasing efforts to audit or otherwise regulate their own compliance with the applicable laws and regulations. As a result, these hospitals are becoming more aware of the difficulty of sorting the numerous pharmaceutical waste streams that the EPA, Department of Transportation (DOT), Drug Enforcement Administration (DEA), some states agencies and/or other organizations require.

For example, millions of tons of medical waste are generated by hospitals, medical clinics and pharmaceutical manufacturers each year. As much as half of this waste is considered infectious. Until the late 1990s, when the EPA began to enforce tough environmental emission laws most of the infectious waste was treated in thousands of incinerators located throughout the country. This effort has resulted in a significant reduction in the number of incinerators throughout the U.S. Presently, much of the infectious waste generated in the U.S. is treated by alternative technologies such as autoclaves and chemical processors. There is very little choice for hospitals because of the upfront cost and large footprint of the processing equipment. Although many companies have offered different kinds of equipment, the prices vary from a few hundred thousand dollars for smaller units to a few million for large units. Because of the long cycling times to decontaminate the waste, the equipment typically is very large in order to provide acceptable throughput. There are also several companies that provide a service to hospitals by utilizing chemical processors mounted on trucks. They go to a facility and decontaminate the infectious waste, allowing the treated waste to be hauled to a local landfill. There are concerns that this technology may not completely treat the waste in all circumstances and the chemical residue left after processing may remain an ecological issue.

Increasingly, hospitals are required to comply with the recent and projected enforcement of federal and state hazardous pharmaceutical waste regulations. Currently, clinicians must manually sort pharmaceutical waste streams into different colored containers for proper disposal of the separate waste streams. It is often not clear to a clinician which pharmaceuticals or waste materials are hazardous simply by looking at the container. Such confusion may lead to clinicians throwing hazardous drugs in non-hazardous containers such as sharps containers, infectious waste bags, non-hazardous pharmaceutical containers or simply down the drain.

Further, some pharmaceuticals, which are referred to as controlled substances, are further regulated by other laws and standards, such as, for example, the Controlled Substances Act of 1970 (CSA). In general, the CSA and similar laws were passed to control the manufacturing, distribution, dispensing and other aspects related to the handling of controlled substances in the United States. As such, it establishes requirements that form a closed system for legitimate handlers of controlled substances to prevent the diversion of the drugs into illicit markets. Among other things, the CSA separates controlled substances into 5 different groups or Schedules. The second of these, Schedule II (CII), includes substances which have accepted medical uses in the U.S, but have a high potential of abuse. The substances listed in CII have special disposal requirements that are different from substances categorized in some of the other CSA schedules (e.g., Schedule III, IV or and V).

The Drug Enforcement Administration (DEA) is the Federal law enforcement agency responsible for enforcing the CSA. Substances listed in Schedules III, IV and V can be disposed of following the rules from CFR Titles 40 and 29. CII substances, however, require special handling. The CSA allows CII controlled substances to be disposed of in several ways. For example, CII substances can be destroyed in the presence of a DEA agent or some other authorized person. Alternatively, a DEA Special Agent in Charge can make a determination on a particular disposal method so as to ensure that the CII substances do not become available to unauthorized persons.

Destruction methods currently involve collecting the wasted CII substances at hospitals, pharmacies and other facilities where they are generated, and transferring them to DEA-registered incinerators for final destruction. In order to prevent unwanted diversion of the CII substances, such methods typically require detailed tracking and accounting of the wasted substances. In current practice the tracking and accounting of the wasted CII substances tends to be performed manually, making it tedious, inefficient and generally inaccurate.

Currently, in order to avoid the tedious tracking and accounting of wasted CII substances, the DEA has deemed disposing of CII substances into sewer lines to be one preferred disposal method for hospitals, pharmacies and/or other facilities. However, this method generally conflicts with the EPA's mission of reducing or preventing water pollution. For example, current water treatment facilities that treat wastewater are generally not equipped to remove or destroy CII substances. Certain states, such as California, also have laws that make it illegal for hospitals to dump such drugs into the sewer system. In the face of this conflict, an easier, more efficient and more accurate CII waste disposal method is needed to satisfy both drug enforcement and environmental protection laws and regulations.

### SUMMARY

According to some embodiments, a method for tracking a controlled substance before and after such controlled substance is administered to a patient comprises obtaining information regarding a controlled substance to be administered to a patient and a corresponding residual volume of the controlled substance. The residual volume of the controlled substance can comprise an amount of the controlled substance that is not administered to the patient and that is designated for disposal. The method additionally comprises obtaining information from a spent drug container configured to receive the residual volume of the controlled substance. In one embodiment, the spent drug container comprises a closure member to secure the residual volume of the controlled substrate within the spent drug container.

According to some embodiments, the method further comprises electronically accessing a database of a waste sorting system, wherein the database comprises waste item classification information. In some embodiments, the waste sorting system comprises a plurality of waste container compartments, each of the waste container compartments being configured to receive a removable waste container. In some embodiments, a movable lid is coupled to at least one removable waste container of the waste sorting system. In one embodiment, each of the removable waste containers is associated with at least one of a plurality of waste categories, wherein each of the movable lids is configured to be selectively moved between an open position and a closed position. In some embodiments, the movable lids are configured to selectively expose an opening in the corresponding removable waste containers when in an open position. In one embodiment, at least one of the removable waste containers of the waste sorting system is configured to receive controlled substances and/or any other regulated substance.

According to some embodiments, the method further comprises electronically assigning the spent drug container comprising the residual volume of the controlled substance to at least one waste category based at least in part on the obtained information and the waste item classification information and providing access to an interior of the removable waste container associated with said waste category to permit disposal of the spent drug container and the controlled substance positioned therein. In some embodiments, the method comprises prompting a user to enter information regarding the quantity of the residual controlled substance and comparing the quantity of the residual volume of the controlled substance within the spent drug container with a quantity of the controlled substance prior to administration to the patient and a quantity of the controlled substance intended to be administered to the patient, thereby tracking the controlled substance before and after administration to the patient.

According to several embodiments of the invention, a system and method to efficiently and effectively track and sort controlled substances (e.g., a narcotic or other CII substances) are provided. Drugs that can be accommodated according to several embodiments herein include, but are not limited to, opium, morphine, codeine, hydromorphone, methadone, meperidine, cocaine, oxycodone, anileridine, phenylacetone, oxymorphine, amphetamine, methamphetamine, phenmetrazine, methylphenidate, amobarbital, pentobarbital, secobarbital; fentanyl, etorphine hydrochloride, and phencyclidine. The drugs can be in solid, liquid, gaseous or gelatinous form.

In one embodiment, the invention comprises a method for sorting and tracking a controlled substance before and after administration to a patient. In one embodiment, the method comprises providing a spent drug container for receiving a residual controlled substance, wherein the residual controlled substance is the amount of controlled substance that is designated for disposal; obtaining information regarding the quantity of the controlled substance to be administered to a patient; providing a medical waste sorting system comprising a plurality of waste container compartments for housing a plurality of removable waste containers, providing an automatically movable lid coupled with each of the removable waste containers; wherein each of the removable waste containers is associated with at least one of a plurality of waste categories, wherein the movable lid is movable to an open position and a closed position; obtaining information from the spent drug container; electronically accessing a database comprising waste item classification information; electronically assigning the spent drug container to at least one waste category based at least in part on the obtained information and the waste item classification information; automatically opening the lid coupled to the removable container associated with the waste category to permit disposal of the spent drug container; automatically locking the lid coupled to the removable container in the closed position after disposal of the spent drug container; prompting a user to enter information regarding the quantity of the residual controlled substance; and electronically comparing the quantity of the residual controlled substance with the quantity of controlled substance prior to administration to the patient, thereby tracking the controlled substance before and after administration to the patient. The steps identified in any of the methods described herein are performed by a machine (e.g., the control system, processor, barcode readers, key readers, electronic components, etc.) in several embodiments.

In another embodiment, the invention comprises a sorting system for sorting and tracking a controlled substance before and after administration to a patient. In one embodiment, the system comprises: a plurality of waste container compartments for housing a plurality of removable waste containers, wherein each of the removable waste containers comprises an opening; at least one automatically movable lid coupled with each of the removable waste containers; wherein each of the removable waste containers is associated with at least one of a plurality of waste categories, wherein the movable lid is movable to an open position and a closed position; an input device configured to receive information associated with a spent drug container, wherein the spent drug container comprises a residual controlled substance, wherein the residual controlled substance is the amount of controlled substance that is designated for disposal; an input device configured to obtain information regarding the quantity of the residual controlled substance, a control system, wherein the control system is configured to compare the quantity of the residual controlled substance with a quantity of the controlled substance prior to administration to the patient, thereby tracking the controlled substance before and after administration to the patient; wherein the control system is further configured to assign the residual controlled substance to at least one waste category based at least in part on the inputted information and a waste item classification information contained in a database and automatically open the lid coupled to the removable container associated with the waste category; and wherein the control system is further configured to lock the lid coupled to the removable container associated with the waste category after the spent drug container is disposed. A sorting system according to any one of the preceding claims, further comprising an input device configured to obtain information regarding the quantity of the drug to be administered to a patient.

In one embodiment, the input device configured to obtain information regarding the quantity of the spent drug comprises a touch screen or keyboard, wherein the information can be entered by a user upon a prompt or query. In one embodiment, the input device configured to receive information associated with a spent drug container can include a touch screen or keyboard, wherein the information can be entered by a user upon a prompt or query. In one embodiment, the input device configured to receive information associated with a spent drug container comprises a barcode reader configured to read a barcode on the spend drug container.

In any of the embodiments described herein, the spent drug container comprises a vessel, such as a cup. The vessel can have graduations to facilitate measurement. In one embodiment, the cup serves as a vessel for receiving the residual controlled substance which was previously contained, for example, in a vial, bottle or syringe. In some embodiments, the spent drug container comprises a vial, bottle, a syringe, or an intravenous (IV) bag.

In one embodiment, obtaining information from a spent drug container comprises scanning a barcode associated with the spent drug container via a barcode reader.

In one embodiment, obtaining information from a spent drug container comprises prompting a user to input data regarding the controlled substance and/or spent drug container.

In one embodiment, obtaining information from a spent drug container comprises prompting a user to input data regarding the controlled substance and/or spent drug container via a touch screen or keyboard.

In any of the embodiments described herein, one or more (or all) of the removable waste containers comprises an opening and a machine readable identification key. In one embodiment, the machine readable identification key is read to determine the waste category associated with the container via a key reader.

In any of the embodiments described herein, the quantity of the controlled substance that should have been administered to the patient is calculated by comparing the quantity of the residual drug with the quantity of the dispensed drug.

In any of the embodiments described herein, the quantity of the controlled substance that should have been administered to the patient is reported to a user.

In any of the embodiments described herein, the quantity of the controlled substance that should have been administered to the patient is compared to a quantity that was actually administered to the patient.

In any of the embodiments described herein, a manifest is generated containing information regarding the quantity of the residual controlled substance. The manifest can be printed or generated in an electronic form.

In any of the embodiments described herein, the waste item classification information comprises classification information based on environmental or drug enforcement regulations contained in a database.

In any of the embodiments described herein, at least one of the moveable lids is configured to be manually closed upon disposal of the waste item.

In any of the embodiments described herein, at least one of the moveable lids is configured to be automatically closed upon disposal of the waste item.

In yet another embodiment, the invention comprises a method of sorting controlled substances. In one embodiment, the method comprises scanning a bar-coded drug container, wherein the bar-coded drug container comprises a drug waste; accessing a database to assign the drug waste to a waste category; identifying the drug waste as a controlled substance based on the waste category; prompting a user to enter the user's identification (or otherwise obtaining a user's identification information); prompting a witness to enter the witness's identification (or otherwise obtaining a witness's identification information); scanning a bar-coded vessel, wherein the vessel is configured to receive a residual portion of the controlled substance from the bar-coded drug container, wherein the residual controlled substance is the amount of controlled substance that is designated for disposal; prompting the user to enter the quantity of the residual controlled substance placed in the vessel (or that should be placed in the vessel) after the user has transferred the controlled substance from the drug container to the vessel; and prompting the user to dispose of the vessel in the appropriate waste container. A lid coupled to the appropriate waste container is automatically opened to permit disposal and automatically locked after disposal. Because controlled substances are disposed, many of the containers are restricted access containers. Obtaining a user's (or witness's) identification includes scanning of a badge or biometrics scanning. A user's identity and/or location can be determined in some embodiments.

Use of vessels (such as cups) is particularly advantageous in certain embodiments because it prevents co-mingling of drugs in a waste container. Thus, for example, opium and morphine can be discarded into single waste container because they are each self-contained in their own individual vessels (e.g., cups). Thus, systems and methods of self-containing drugs to minimize co-mingling are provided in several embodiments herein.

### BRIEF DESCRIPTION OF DRAWINGS

These and other features, aspects and advantages of the present disclosure are described herein in connection with certain preferred embodiments, in reference to the accompanying drawings. The illustrated embodiments, however, are merely examples and are not intended to limit the disclosure presented herein. The drawings include the following figures.

FIG. 1 illustrates a perspective view of a waste sorting and disposal station comprising a plurality of containers according to one embodiment;

FIG. 2 illustrates a perspective view of a waste sorting and disposal station comprising a plurality of containers and a user positioned immediately adjacent to the station and holding a handheld device configured to be in data communication with the station according to one embodiment;

FIG. 3 illustrates a perspective view of a waste sorting and disposal station comprising a plurality of containers and a controlled substance receptacle according to one embodiment;

FIG. 4 illustrates a perspective view of a separate controlled substance receptacle according to one embodiment;

FIG. 5 illustrates a side view of one embodiment of a vessel or cup configured to receive one or more controlled substances;

FIG. 6 illustrates a side view of another embodiment of a vessel or cup configured to receive one or more controlled substances;

FIG. 7 illustrates the vessel or cup of FIG. 5 with its cap removed and receiving waste materials therein according to one embodiment;

FIG. 8 illustrates a front view of a vessel or cup dispensing system according to one embodiment;

FIG. 9 illustrates a front view of a vessel or cup dispensing system comprising, inter alia, a label printer, according to one embodiment;

FIG. 10 illustrates a flowchart showing one embodiment of a waste sorting and disposal method; and

FIG. 11 illustrates a flowchart showing another embodiment of a waste sorting and disposal method configured to accommodate controlled substances or other regulated waste.

### DETAILED DESCRIPTION

There remains a need for a system that allows clinicians to more easily sort medical waste items, including controlled substances (e.g., CII pharmaceuticals) and other regulated waste for appropriate disposal. There also remains a need for an automated system of waste disposal that encourages and facilitates hospital compliance with the relevant federal (e.g., EPA, DEA, etc.), state and/or other types of waste disposal and handling rules and regulations.

### Collection, Sorting and Disposal of Controlled Substances and Other Regulated Materials

For any of the embodiments disclosed herein, or equivalents thereof, the corresponding waste sorting and disposal devices, systems and methods can be configured to receive, sort, handle and track the disposal of highly regulated materials, such as, for example, CII pharmaceuticals and/or other DEA-regulated substances, other materials susceptible to theft or misuse and/or the like. As a result, any of the waste sorting stations, other devices, systems and/or methods discussed or illustrated herein can be modified in accordance with the following disclosure to adequately, accurately, efficiently and/or safely handle the disposal of such controlled or other regulated substances.

As discussed in greater detail below, a waste sorting and disposal device or system can be at least partially automated. In some embodiments, such sorting systems comprise a plurality of individual sorting and disposal stations connected or otherwise operatively coupled to one another via a centralized or de-centralized network. Alternatively, a medical waste sorting system can comprise one or more stand-alone sorting and disposal stations configured to operate independently of one or more other devices. Although some of the embodiments disclosed herein are described in the context of individual stand-alone stations, such individual stations can be connected or otherwise operatively coupled to each other in a networked system to provide additional functionality and/or to improve efficiency. Conversely, some embodiments disclosed herein are described in the context of networked systems, certain features and advantages of which can be readily applied to individual stand-alone systems. As used herein, the term “sorting” is a broad term and shall be given its ordinary meaning and generally refers to the distribution of one or more waste items into one or more appropriate waste receptacles. As used herein, the term “disposing” is also a broad term and shall be given its ordinary meaning and shall, in some embodiments, generally refer to the discarding or “throwing out” of one or more items of waste into an appropriate receptacle. As used herein, the terms receptacle and container are broad terms that can be used interchangeably.

According to certain embodiments, a waste sorting and disposal station comprises a sorting station or machine, which includes a series of container positions or compartments. Each compartment can be configured to receive a removable container for collecting waste belonging to a particular category or classification. Further, each container can be configured to receive a liner that is removably positioned therein. Some embodiments of a sorting station comprise a waste-identifying device, a processor configured to carry out a waste-sorting algorithm, a waste-sorting mechanism and/or other components, devices and features. As used herein, the term “removable” shall be given its ordinary meaning, and is used to describe items (e.g., containers, liners, etc.) that are disposable and/or reusable.

In some embodiments, a sorting machine comprises one or more sensors for determining the presence of a container, a type of container, a volume, weight or fill level of a container and/or any other property or characteristic of a container. In some embodiments, the vessel comprises or is operatively coupled to one or more sensors. In some embodiments, a sorting machine/station includes and/or is coupled to one or more computer peripherals, such as, for example, automatic or manual user input devices (e.g., barcode scanners, radio frequency identification (RFID) devices, other types of scanners or readers, touchscreens, keyboards, keyboards, pointer devices, etc.), display devices, sound-producing devices (e.g., speakers or buzzers), other peripheral device.

According to some embodiments, several container types are provided in a sorting device or system, such that each type of container is associated with one or more categories or classifications of pharmaceutical and/or other waste that is generated at a hospital, clinic, pharmacy and/or similar facility. For example, a single container can be associated with a single waste category. In other embodiments, a single container is associated with multiple (e.g., two, three, more than three, etc.) waste categories. As discussed in greater detail herein, a waste sorting and disposal station or system can include one or more containers that are configured to receive controlled substances (e.g., CII pharmaceuticals) and/or other regulated materials. The containers can include liners and/or other protective members which protect the containers. Such liner and/or other members can be configured to be removably positioned within the containers. In some embodiments, a controlled substance container is incorporated into the structure of a single waste sorting and disposal device (e.g., cart-on-wheels, wall or floor mounted unit, etc.). Alternatively, however, a controlled substance container can be provided as a separate item that can be physically and/or operatively connected to one or more waste sorting and disposal stations. In arrangements where the controlled substance container is separate from the waste sorting station, such a controlled substance container can be selectively attached (e.g., removably, permanently, etc.) to one or more waste sorting and disposal stations, as desired or required.

In some embodiments, container types can include controlled substance containers (e.g., configured to receive CII or other DEA-regulated pharmaceuticals or substances, other regulated materials and/or the like), sharps containers, chemotherapy agent containers, infectious waste containers, ignitable waste containers, hazardous P-list waste containers, hazardous U-list waste containers, toxic pharmaceutical waste containers, non-toxic pharmaceutical waste containers, chemotherapy sharps containers, corrosive waste containers, or reactive waste containers. Additional container types can also be used as desired. In one embodiment, the container types are pre-designated by the container provider. Further, the container types can be assigned by the hospital so that the hospital can selectively and uniquely customize its waste sorting system(s). For example, some hospitals may wish to define their own waste categories in order to comply with internal goals, targeted rules and/or regulations and/or the like. Accordingly, user-defined container types can be provided either in addition to or in lieu of standard or typical container types.

Any of the waste sorting and disposal devices, systems and methods disclosed herein can comprise one or more waste identifying devices or mechanisms. In several embodiments, the waste identifying mechanism is configured to identify a particular item of waste. Identification of a waste item can be accomplished prior to depositing such waste item into the appropriate container. Identification of the waste item can be accomplished by scanning a barcode, reading a label (e.g., using an optical scanner and Optical Character Recognition software), reading a Radio Frequency identification (RFID) tag, chemical sensors, spectroscopic analyzers, measuring or evaluating any other qualitative parameter of the waste item presented for identification and/or any other device or method. In other embodiments, an item of waste is identified by the manual input of information by a nurse, physician, other clinician or any other user discarding a particular waste item. Such information can include, without limitation, a National Drug Code (NDC), a generic name, a chemical name, an abbreviated name of the drug (or mnemonic), other data associated with a particular item of waste and/or the like. In one embodiment, a user can simply read a waste identifier (e.g., alphanumeric code, graphical pattern, etc.) from an item of medical waste and enter such identifier into the system via a keyboard, touch screen or other user input device.

Once an item of waste has been automatically or manually identified, a sorting algorithm within or operatively coupled to the waste sorting system can accurately determine to which of a plurality of waste categories that particular waste item belongs. The station can be configured to indicate the proper container for disposal of the waste item to the user. For example, in some embodiments, the station indicates a correct container by opening a door, lid, cover, hatch or the like or otherwise providing access to the desired waste container. Alternatively, such an indication can be provided by illuminating a light, displaying a name or number of a container on a display device, providing an audible or other perceivable message and/or otherwise identifying the proper container.

In some embodiments, the waste sorting device or system comprises a plurality of openings that provide access to corresponding containers. For example, each of the containers can be configured to interface with an automatically operable lid, door, cover or other closure member to identify the container opening to the user. Alternatively, the sorting device can be configured to provide access to an appropriate container in other ways, such as, for example, by moving a container relative to the machine in order to present a container opening to a user. Further, the sorting mechanism can include a series of lights or other indicators configured to alert the user of the correct container into which a particular item of waste is to be deposited. Alternatively, the sorting mechanism can include an apparatus configured to receive an item of waste from a user and physically convey the item to the appropriate container.

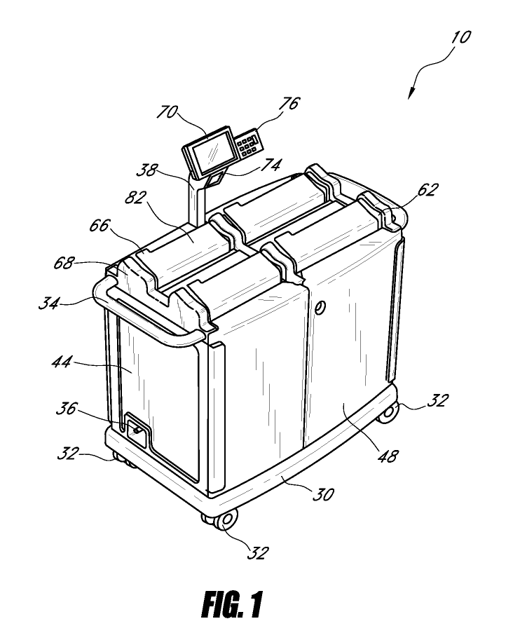

One embodiment of a waste sorting and disposal station 10 is illustrated in FIG. 1. In the depicted arrangement, the station 10 includes a plurality of containers (not shown), access to which can be selectively provided by movement of the corresponding lids 82 or other closure devices. In addition, the waste sorting and disposal station 10 can include a display 70 or other device configured to provide data and other information to a user. Further, the station 10 can comprise an identification device 74 that is adapted to read or otherwise detect identifying information regarding a waste item, a nurse, other clinician or other user of the sorting and disposal station. For example, the identification device 74 can comprise a barcode scanner, a radio frequency identification (RFID) reader, a magnetic strip reader and/or any other scanner or reading device. According to some arrangements, the identification device 74 is configured to detect a National Drug Code (NDC) barcode placed on a vial, ampoule, syringe or other pharmaceutical or medical container or item. In other embodiments, the identification device 74 is adapted to automatically detect an RFID or similar device positioned on a label or other portion of a waste item brought in proximity to the identification device 74.

With continued reference to FIG. 1, a waste sorting and disposal station 10 can additionally include a display 70 and/or a user input device 76. Such features can allow a user to enter additional information regarding a waste item being discarded, receive instructions or other information from the device and/or the like. For example, the display 70 can include a monitor, a touchscreen and/or any other device configured to visually provide information to the user. In addition, the user input device 76 can comprise a keyboard, keypad, touchscreen (e.g., having softkeys) and/or the like. In some embodiments, as discussed in greater detail herein, a user provides information to the sorting and disposal system that cannot be automatically detected. For instance, for pharmaceutical or medical waste items that do not include a barcode (e.g., NDC), a RFID or some other identifier, a nurse or other user can manually enter the necessary information regarding such items (e.g., name of waste, concentration, other identifier, etc.). Further, the user input device 76 can be configured to allow a user to enter other information regarding a particular waste item, such as, for example, volume, weight, quantity or other measure of amount of waste being discarded and/or the like.

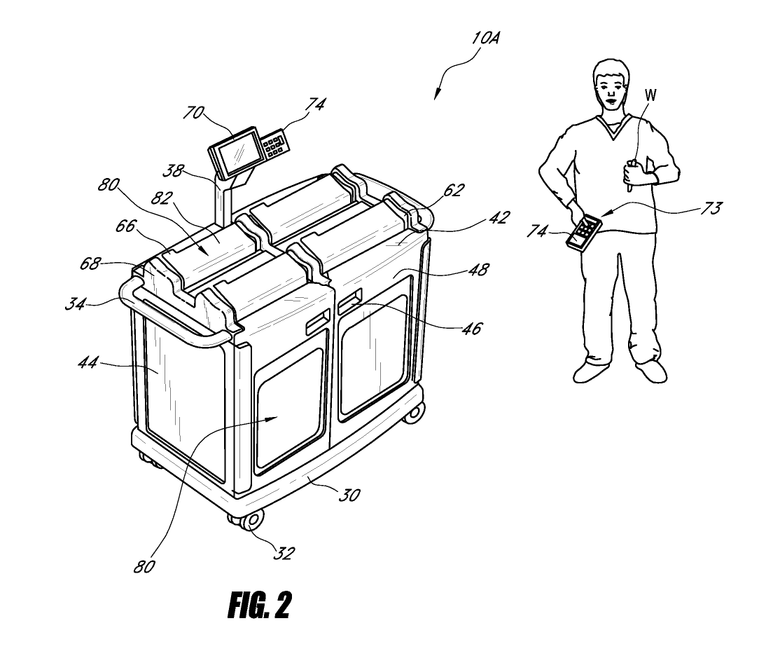

Another embodiment of a waste sorting and disposal station 10A is illustrated in FIG. 2. As shown, the system can comprise a handheld device 73 that is operatively connected to the station 10A. Accordingly, one or more features or components of the sorting and disposal station 10A can be incorporated into the handheld device 73. For example, the handheld device 73 can include an identification device 74 (e.g., barcode scanner, RFID reader, etc.), a data input device (e.g., keyboard, keypad, touchscreen, etc.), a display (e.g., monitor, touchscreen, etc.) and/or any other feature, as desired or required. In some arrangements, the handheld device 73 is configured to communicate (e.g., using one or more wireless and/or hardwired connections) to one or more waste sorting and disposal devices and/or stations. Accordingly, a nurse or other user can scan a waste item, enter necessary information, receive instructions and/or perform any other task related to the disposal of a waste item W with the assistance of a handheld device 73.

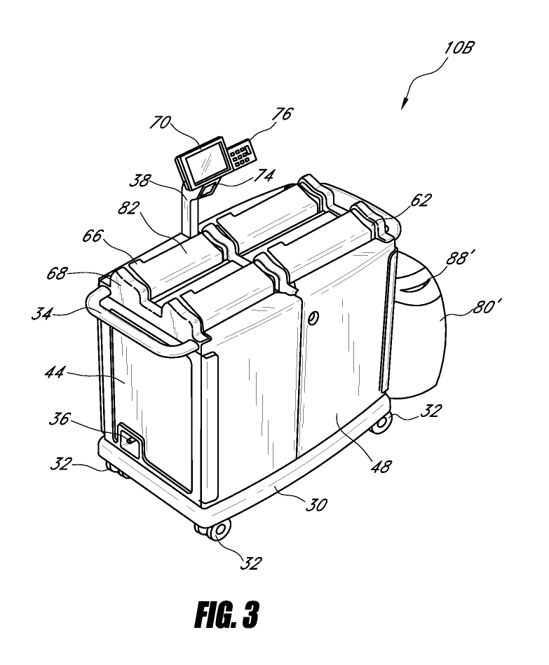

As discussed herein, waste items comprising one or more controlled substances (e.g., CII pharmaceuticals, other DEA-regulated materials, etc.) can be received within one or more containers of a main sorting and disposal station, such as those illustrated in FIGS. 1 and 2. As used herein, “controlled substance” is a broad term and shall be given its ordinary meaning and generally includes, without limitation, any DEA-regulated pharmaceutical, non-pharmaceutical and/or other substance, any other substance that is regulated by a government agency, hospital or other healthcare facility, any other substance that may need to be tracked for regulatory or compliance purposes and/or the like. As illustrated in FIG. 3, a waste sorting and disposal station 10B can include a separate container 80′ or receptacle that is configured to receive controlled substances and that may be removably or permanently attached to a main sorting and disposal station. The controlled substance container 80′ can be secured to a sorting and disposal station using screws bolts, tabs, clips, other fasteners, welds, adhesives and/or any other temporary or permanent attachment method or device.

With continued reference to FIG. 3, a controlled substance container 80′ can include one or more slots 88′ or other openings through which waste items (or vessels/cups into which such waste items are placed) can be discarded. In some embodiments, the slot 88′ or other opening is configured to prevent removal of any waste items deposited therethrough. In addition, the container 80′ can be adapted to prevent waste (e.g., liquids, solids, gels, etc.) deposited within an interior of such container from exiting the slots 88′ or other openings (e.g., in some arrangements, even if the container 80′ is moved from its upright position). Such configurations can help ensure that controlled substances and/or other waste items placed within the container 80′ do not escape or otherwise become intentionally or inadvertently compromised. For example, the interior cavity of such a container or receptacle 80′ can include a tortuous path that helps maintain liquids, solids and other materials therein and generally prevents spills or leaks.

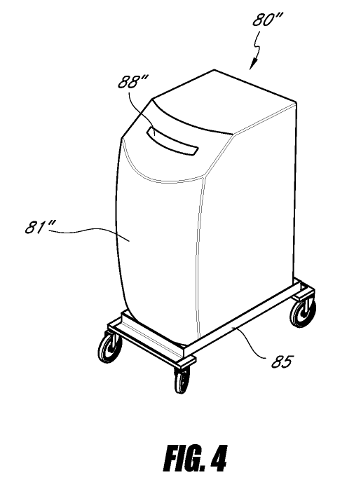

In other arrangements, a controlled substance container 80″ is separate from the main sorting and disposal station. As illustrated in FIG. 4, the controlled substance container 80″ can be positioned on a wheeled cart 85 or can be configured to otherwise be rollable or movable. Alternatively, the container 80″ can be mounted on a wall, at least partially secured to a sorting station, secured to a floor or positioned in any other location of a hospital, pharmacy and/or the like. As illustrated in FIG. 4, a controlled substance container 80″ can include one or more viewing windows or strips 81″ to allow visual verification of a fill level. One or more other devices or methods of detecting a fill level of the container 80″ can be used, either in lieu of or in addition to the viewing windows or strips 81″.

Any of the embodiments of a waste container or receptacle disclosed herein, including but not limited to those that are configured to be positioned within a main sorting station (e.g., FIGS. 1-3) or those configured to be used as stand-alone units (e.g., FIG. 4), can be configured to receive a liner or other member adapted for selective placement within the interior cavity of the container or receptacle. Such liners or other devices can help to generally protect the containers or receptacles, to extend the life of the containers and receptacles, assist with the handling and transport of the waste items collected therein and/or provide one or more additional benefits or advantages. In addition, liners can facilitate emptying and cleaning of the containers and receptacles. Accordingly, the various activities associated with collecting waste items within the containers or receptacles can be simplified and the related operational and capital costs can be advantageously reduced. Additional details regarding the use of disposable liners in containers and other receptacles for waste sorting and disposal system are provided in U.S. Pat. No. 7,660,724, titled REMOVABLE LINERS FOR WASTE SORTING SYSTEM and issued on Feb. 9, 2010, the entirety of which is hereby incorporated by reference herein. In addition, non-limiting examples of waste sorting systems and methods are disclosed in U.S. Pat. No. 7,275,645, titled HANDHELD MEDICAL WASTE SORTING DEVICE and issued on Oct. 2, 2007, the entirety of which is hereby incorporated by reference herein.

According to certain embodiments, a waste item (e.g., a CII pharmaceutical or other regulated waste) can be deposited directly into a controlled substance container or receptacle 80′, 80″, regardless of its exact size, shape, state (e.g., liquid, solid, etc.), the manner in which it is contained, if at all (e.g., vial, ampoule, syringe, loose form, etc.) and/or any other details related to the waste item. For example, according to some embodiments, a controlled substance container 80′, 80″ or receptacle is adapted to accept both solid and liquid forms of a regulated drug waste. In some embodiments, the containers or receptacles 80′, 80″ comprise one or more solidifying agents and/or other substances that help solidify, neutralize, deactivate and/or otherwise treat liquid forms of a regulated drug waste. In some embodiments, the solidifying agent includes materials capable of absorbing at least a portion of a liquid. For example, such absorbent materials can include ceramic materials, sponge materials, powders, other porous materials and/or the like. In other arrangements, a controlled substances container or receptacle is configured to render waste items non-recoverable by providing a substance that can react chemically with waste items.

### Controlled Substance Vessels

In some embodiments, it may not be possible or desirable to combine waste items that comprise different types of controlled substances (e.g., a CII pharmaceutical) and/or another regulated materials in a single container or receptacle. For example, some waste haulers and treatment facilities of waste comprising controlled substances and/or other regulated waste are not willing and/or able to accept commingled waste. Accordingly, as discussed in greater detail herein, an item that includes such regulated waste may need to be initially transferred to a controlled substance (CS) vessel (e.g. a cup or other enclosure) before being deposited into a common container or receptacle 80′, 80″. As used herein, vessels and cups are broad terms that include any type of container capable of receiving waste or a waste item. The terms vessel and cup may be used interchangeably. Accordingly, the term vessel shall be given its ordinary meaning and shall include containers, receptacles, packaging, holders and, without limitation, any enclosure configured to receive liquids, solids and/or any other materials. Vessels can comprise one or more suitable materials, such as, for example, plastics, elastomers, glass, or paper-based or wood-based materials, metals, alloys and/or any other natural and/or synthetic material. Vessels can be biodegradable or non-biodegradable, as desired or required. The capacity of a vessel can range from about 0.1 ml to about 1 L (e.g., approximately 0.1 ml, 0.5 ml, 1 ml, 5 ml, 10 ml, 50 ml, 100 ml, 200 ml, 300 ml, 400 ml, 500 ml, 600 ml, 700 ml, 800 ml, 900 ml, 1 L, volume between the foregoing values, etc.). In other arrangements, the capacity of a vessel can be less than about 0.1 ml or greater than about 1 L, as desired or required. In one embodiment, vessels comprise graduated vessels or containers (e.g., graduated cylinders) that can hold, for example, about 0.1 ml, 0.5 ml, 1 ml, 5 ml, 10 ml, 25 ml, 50 ml, 100 ml, 500 ml or 1 L of liquid waste and/or other type of waste.

Use of vessels (such as cups) can be particularly advantageous in certain embodiments, because it reduces or minimizes the co-mingling of drugs in a waste container. Thus, for example, opium, morphine and/or other narcotics and/or other highly-regulated pharmaceuticals can be discarded into single waste container as they are each self-contained in their own individual vessels (e.g., cups).

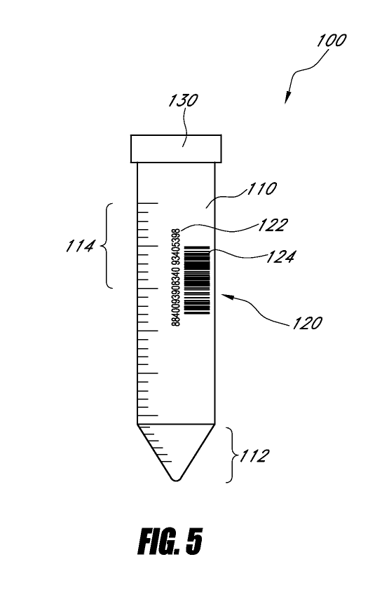

One embodiment of a vessel or cup 100 is illustrated in FIG. 5. As shown, the CS vessel or cup 100 can include a generally cylindrical main body portion 110 that is graduated. The graduation marks 114 can advantageously assist a user to accurately determine the volume of a waste material contained within the vessel or cup 100. For example, the nurse, other clinician or other user can use such graduation marks when entering the volume being discarded into the system. Further, the main body portion 110 can terminate in a generally conical lower portion 112, which is configured to help a user more accurately estimate a volume of waste material situated therein. In the depicted arrangement, the CS vessel or cup 100 includes a lid 130, cap or other closure member that is configured to be secured along the top of the main body portion 110. In some embodiments, the lid 130 or other closure is designed and otherwise adapted to be secured to the main body portion 110 in a manner that prevents or reduces the likelihood of its removal without destroying the vessel or cup 100 or without the assistance of a special tool. Such a feature can help ensure the controlled substances or other materials deposited into the interior of the vessel or cup 100 are not intentionally or accidentally compromised. The lid or cap 130 can be secured to the main body portion 110 using a threaded connection, a snap connection and/or any other attachment method or feature. To help ensure that waste materials do not leak out of the vessel or cup 100, one or more sealing members (e.g., gasket), adhesives and/or other features or materials can be provided generally between the main body portion 110 and the lid 130. In some embodiments, once secured to the main body portion, the lid 130 creates a generally leak-proof environment within the interior of the vessel or cup 100. Thus, once closed, the vessels or cups 100 can be generally water-tight or air tight (or substantially water-tight or air-tight), thereby reducing the likelihood of leaks, evaporation, contamination with the outside environment and/or the like. In some arrangements, the lids 130 are hermitically sealed to the adjacent portions of the vessel or cup 100. The lids 130 or other closure members can be locked or sticker peeled.

Although the CS vessel or cup 100 illustrated in FIG. 5 comprises a generally cylindrical shape with a conical bottom, a vessel or cup 100 can include a different shape, size, configuration and/or other property or characteristic, as desired or required for a particular use or application. Further, the CS vessel or cup 100 can comprise one or more rigid or semi-rigid materials, such as, for example, a polymeric material, glass, metal, alloy and/or the like. In some embodiments, the vessels or cups have a capacity of approximately 0.5 ml to 30 ml, such as, for example, 0.5 ml, 1 ml, 2 ml, 3 ml, 4 ml, 5 ml, 10 ml, 15 ml, 20 ml, 25 ml, 30 ml, capacities between such values, etc. In alternative embodiments, the capacity of a vessel or cup can be smaller than 0.5 ml (e.g., 0.1 ml, 0.2 ml, 0.3 ml, 0.4 ml, etc.) or greater than 30 ml (e.g., 40 ml, 50 ml, 75 ml, 100 ml, 200 ml, greater than 200 ml, etc.), as desired or required.

With continued reference to FIG. 5, the CS vessel or cup 100 can include one or more identifiers 120. In the illustrated embodiment, such an identifier 120 is located along the main body portion 110 of the vessel or cup 100. However, the identifier 120 can be positioned within or on any other area or region of the vessel or cup 100, such as, for example, the conical lower portion 112, within a wall of the vessel, the lid 130 or other closure and/or the like. As shown, the identifier 120 can comprise a text sequence 122 (e.g., a unique alphanumeric code) and/or a barcode 124. In other arrangements, the vessel or cup identifier 120 includes a RFID device, color or graphical pattern or some other unique marking or device, either in lieu of or in addition to a text sequence 122 or a barcode 124. As discussed in greater detail herein, regardless of the exact nature of the vessel or cup's identifier 120, identifiers 120 used on vessels or cups can be associated with the controlled substance or other waste item placed within a specific vessel or cup 100. Further, the unique identifier 120 may also be associated with the user who deposited the waste item within a vessel or cup 100, one or more witnesses who oversaw the user place the waste item with in the vessel or cup, the various properties and other details related to the waste item (e.g., volume, weight, quantity, concentration, batch number, etc.), the patient, patient room, doctor and other details in connection with which a particular wasted controlled substance is associated and/or the like.

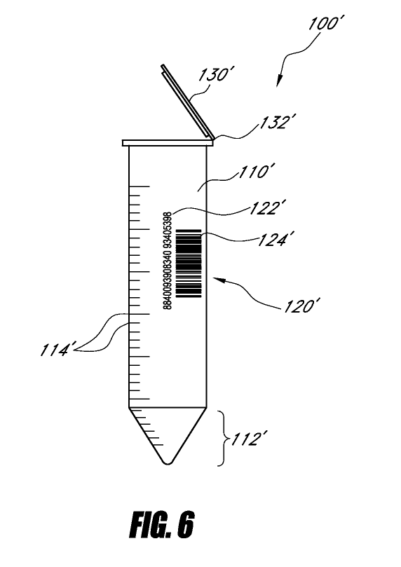

Another embodiment a CS vessel or cup 100′ configured to receive controlled substances or other regulated materials is illustrated in FIG. 6. The depicted vessel or cup 100′ has a similar design as the vessel or cup 100 of FIG. 5 in that it includes a generally cylindrical main body portion 110′, a plurality of graduated marks 114′ for estimating a volume of fluid within the vessel or cup 100′, a conical bottom portion 112′, an identifier 120′ (e.g., barcode 120′, unique alphanumeric text 122′, etc.) and one or more other features. However, as noted above with reference to FIG. 5, the CS vessel or cup 100′ can comprise any other shape, size and/or configuration, as desired or required by a particular application or use.

With continued reference to FIG. 6, the vessel or cup 100′ can include a lid, cap or other closure member 130′ that is generally attached to the main body portion 110′. As shown, the closure 130′ can be joined to the main body portion 110′ using a hinge 132′, joint and/or some other movable connection. Thus, once a waste item has been deposited into the CS vessel or cup 100′, a user can conveniently press down on the lid 130′ to seal the vessel or cup interior. The lid 130′ can be configured to secure to the main body portion using a snap-fit connection, a press-fit connection and/or any other attachment method or feature. In some embodiments, once properly secured to the main body portion 110′, the lid 130′ or other closure cannot be opened without destroying the vessel or cup 100′ or without the use of a special tool. This can help ensure that the waste items (e.g., CII controlled substances, other DEA-regulated materials, etc.) placed within the vessel or cup 100′ cannot be intentionally or accidentally accessed by unauthorized persons.

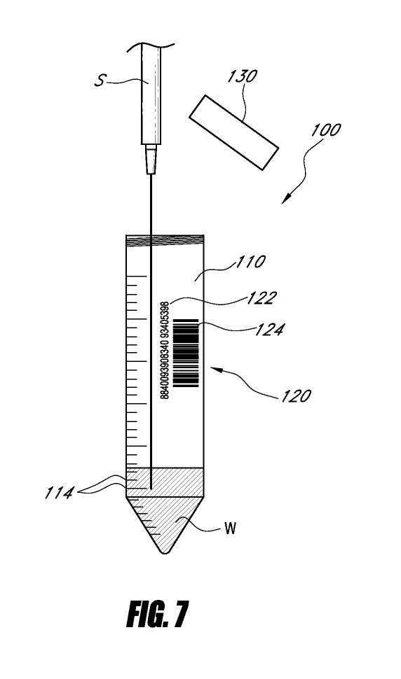

According to certain embodiments, as illustrated in FIG. 7, a nurse or other user can deposit a specific volume of a waste item W into a CS vessel or cup 100. For example, the waste item W can include the unused portion of a controlled substance (e.g., codeine, another CII controlled substance, etc.) from a syringe S directly into the interior of the vessel or cup 100. Thus, in some arrangements, for hygiene and safety purposes, the main body portion 110 is sized, shaped and otherwise configured to permit a needle, syringe or other item to be selectively positioned therein during a wasting procedure without the fear of contacting an interior wall of the vessel or cup 100. Once the waste item W has been adequately transferred into the vessel or cup 100, the lid 130 or other closure can be secured (e.g., via a threaded connection, snap connection, press fit or friction fit connection and/or other type of connection) to the top of the main body portion 110 to ensure that the waste item W remains within the vessel or cup 100.

According to some embodiments, vessels or cups can be color-coded or otherwise distinguished from each other depending on the specific type of controlled substances, other regulated materials and/or other waste materials they are configured to receive. For example, a pharmacy, hospital or other facility can require waste items comprising a CII narcotic (e.g., opium, morphine, codeine, methadone, meperidine, cocaine, oxycodone, etc.) to be deposited in a CS vessel or cup 100 having a first color (e.g., red). Further, waste items comprising a CII stimulant (e.g., amphetamine, methamphetamine, phenmetrazine, etc.) can be deposited in a CS vessel or cup having a second color (e.g., blue), while waste items comprising a CII depressant (e.g., amobarbital, pentobarbital, secobarbital; etorphine hydrochloride, phencyclidine, etc.) can be deposited in a CS vessel or cup having third color (e.g., yellow). A hospital, pharmacy or other facility that disposes of controlled substances and other regulated waste can include more or fewer (or different) categories, as desired or required. Alternatively, vessels or cups 100 can include some other distinctive marking or configuration, such as, for example, other color scheme, a unique pattern, shape, size, label and/or the like, to distinguish between the various waste items that are to be discarded therein.

Accordingly, in some embodiments, when a nurse, other clinician or other user wishes to discard a controlled substance or other regulated waste, he or she selects an unused, sterile vessel or cup 100 that is specifically associated with the substance or item to be wasted. In some embodiments, the vial, ampoule, syringe, packet, capsule and/or other container in which a substance or other item is located can be adapted to indicate a general category with which the substance or item is associated. Further, such containers can include information that associates the substance or item contained therein with a specific type of vessel or cup. For example, a vial, ampoule, syringe or other container can include a color or some other distinguishing graphic, scheme, other marking, shape, size or the like that helps the user associate the materials contained within the ampoule to a specific CS vessel or cup. Thus, in one embodiment, if the ampoule includes a red marking (e.g., dot), a user is alerted that any waste originating from the ampoule should be deposited into a red vessel or cup 100.

In other embodiments, other than the unique identifier 120 (e.g., alphanumeric 122, barcode 124, RFID, etc.), vessels, cups or other containers 100 are configured to have approximately the same size, shape, color and/or other properties and characteristics. In some embodiments, vessels or cups are identical or substantially identical to each other and are supplied without any identifiers. Additional details regarding the various vessel or cup embodiments and the related methods by which such vessels or cups are handled and disposed are provided below.

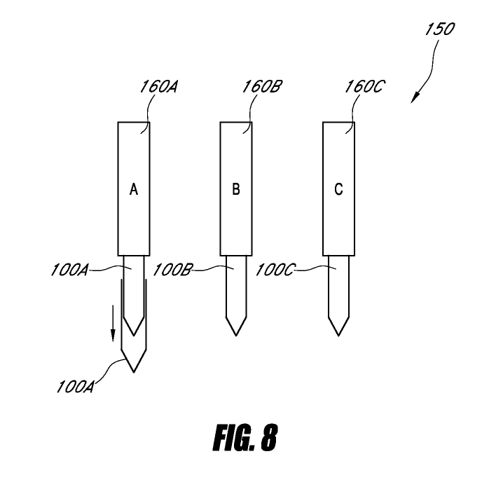

With reference to FIG. 8, CS vessels or cups 100A-100C can be stored in a dispensing system 150. Such a system 150 can advantageously provide convenient access of the vessels or cups to a nurse or other user of a sorting and disposal system. In embodiments where vessels or cups 100A-100C have a different color, shape, size, pattern and/or other characteristic (e.g., based on the type of waste that may be discarded therein), the dispensing system 150 can include two or more dispensing devices 160A-160C. Each of such different dispensing devices can be associated with a specific type of vessel or cup 100A-100C. In other embodiments, as discussed in greater detail herein, each CS vessel or cup can include a unique identifier (e.g., alphanumeric text, barcode, RFID, etc.), which can be linked to or otherwise associated with a specific type of controlled substance or other regulated waste. Alternatively, CS vessels or cups can be supplied or otherwise provided without any unique characteristics or identifiers. Thus, in some configurations, once data and other information (e.g., type, concentration, volume, weight, quantity, etc.) regarding the particular control substance or other waste item are obtained by the system (e.g., using a barcode scanner, RFID reader, user input device and/or any other device positioned on a sorting station, a handheld device, etc.), an adhesive label having a unique barcode or other identifier can be printed or otherwise generated. Such a label can then be secured to the corresponding vessel or cup into which the waste will be placed.

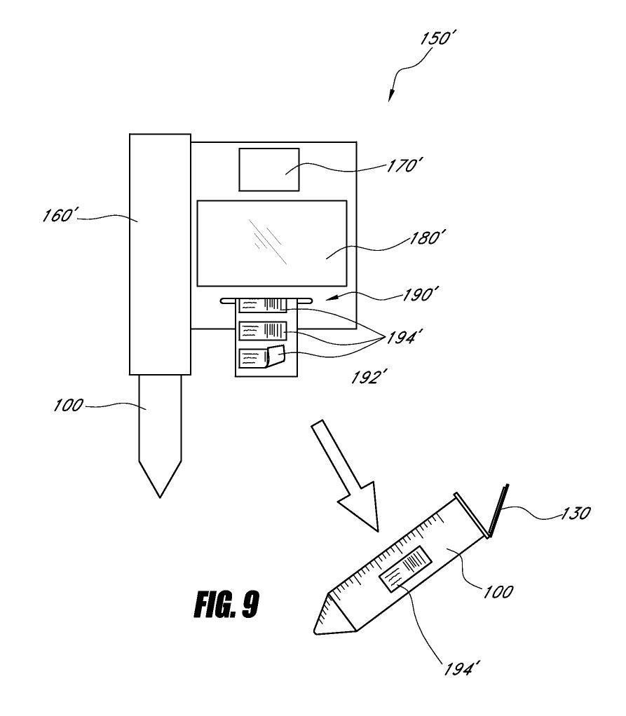

As illustrated in FIG. 9, an identification device 170′ (e.g., barcode scanner, RFID reader, etc.), a touchscreen 180′ configured to both provide information to and receive instruction from a user, a label printer 190′ and/or any other devices can be located on or near a vessel or cup dispensing system 150′. Accordingly, once the user is ready to dispose of a controlled substance or other regulated item or material, he or she can pass the vial, ampoule or other enclosure that contains the substance, item or material to be wasted along or near the identification device 170′. Further, a user can use the touchscreen 180′ or other data entry device to identify the waste and/or provide additional information (e.g., volume, weight and other characteristics of the waste, names of the nurse or other user, patient and/or doctor and/or the like) related to the item or material being discarded. Accordingly, the vessel or cup dispensing system 150′, which in some embodiments in operatively connected to the waste sorting and disposal system (e.g., the system's processor, the sorting database, etc.), can be configured to generate a unique adhesive label 194′. Such a label 194′ can be conveniently secured to the corresponding vessel or cup 100. As illustrated in FIG. 9, in some embodiments, the vessel or cup dispensing system 150′ comprises a label printer 190′ that is adapted to receive a label roll 192′.

In some embodiments, the need for a printed label is eliminated, as each vessel or cup is provided with a unique identifier (e.g., barcode, alphanumeric text, graphical pattern, color scheme, RFID, etc.). Thus, a user may be required to identify both the controlled substance being discarded (e.g., by scanning a barcode or other identifier of the vial, ampoule or other enclosure that houses the substance, by manually entering information regarding the waste, etc.) and the vessel or cup 100 into which the waste controlled substance will be placed (e.g., by scanning a barcode or other identifier of the cup, by manually entering information regarding the vessel or cup, etc.). As a result, the substance, material and/or other item to be wasted can be accurately linked to or otherwise associated with a specific vessel or cup 100.

Regardless of how a vessel or cup 100 is linked or otherwise associated with a waste item that is or will be deposited therein, a handheld device 73 (FIG. 2) can be used to execute at least part of the waste sorting and/or disposal procedure. For example, instead of having a separate identification device 170′ (e.g., barcode scanner) and/or a touchscreen 180′, other display or data entry device at or near each cup dispensing device 150′ (FIG. 9), a nurse or other user can utilize one or more components and/or other features included on a handheld device 73. In some embodiments, a handheld device additionally comprises a printer or other output device configured to generate a unique vessel or cup label, in accordance with the above disclosure.

### Waste Sorting and Disposal Methods

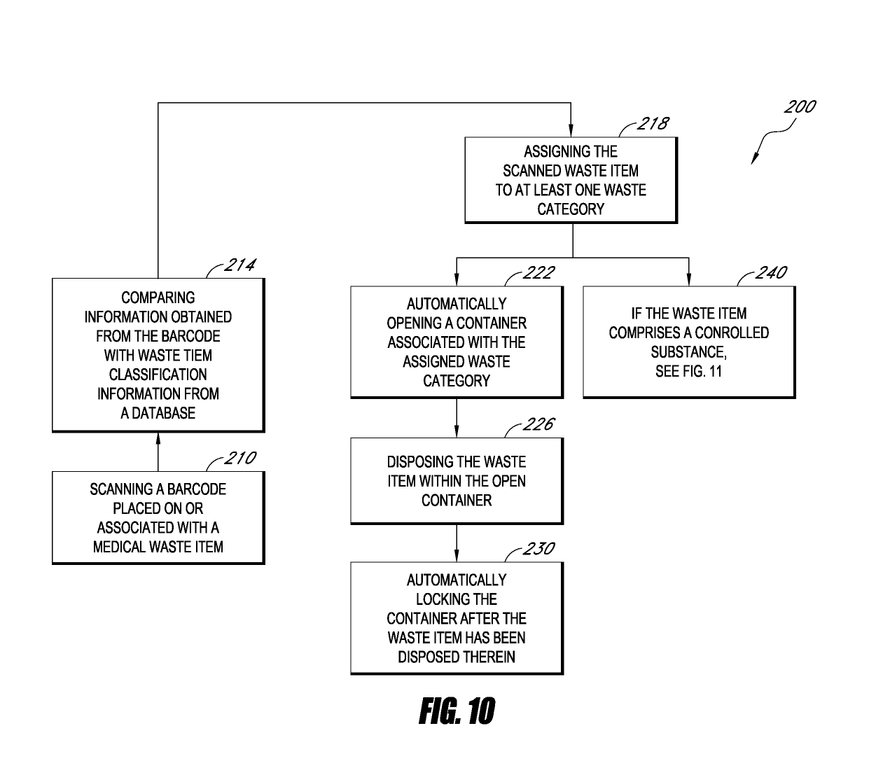

One embodiment of a method 200 for sorting and disposing pharmaceutical and other waste items is schematically illustrated by the flowchart of FIG. 10. For example, once a user wishes to discard of a waste item, he or she takes it to a waste sorting and disposal station and scans 210 a barcode placed on or associated with the waste item. In some embodiments, if the waste item comprises a pharmaceutical vial or ampoule, a NDC barcode can be scanned by the sorting station's barcode scanner. Alternatively, a unique identifier (e.g., another code or pattern, a RFID, etc.) associated with the waste item can be automatically detected by an identification device (e.g., scanner, RFID reader, etc.) of the sorting station. In other arrangements, a user manually enters information regarding the identification and/or other details of the waste item, either in addition to or in lieu of any automatic scanning or other detecting procedures.

Once the necessary identifying information has been received by the sorting and disposal system, the system can compare 214 such information with waste item classification information from a database. Based on such a comparison, the waste item can be assigned 218 to one or more waste categories. In some embodiments, if the waste category is one that does not include a controlled substance or another highly regulated material, a container of the waste sorting and disposal station automatically opens 222, prompting the user to dispose 226 the waste item therein. For example, with reference to the sorting and disposal stations illustrated in FIGS. 1-3, a lid 82 or other container cover can automatically open to reveal the container into which the waste item should be placed. Alternatively, a display 70 or other portion of the station (e.g., a light adjacent to the proper container) can alert the user of the correct container. Thus, the user may need to manually lift the corresponding lid 82 or cover. Once the waste item has been placed into the appropriate container, the lid 82 can be manually or automatically closed. Finally, the container is automatically locked 230, thereby preventing unauthorized access to the internal contents of the container.

According to some embodiments, if the sorting and disposal system determines, after comparing the information regarding the waste item to the database, that the waste item includes a controlled substance (e.g., a CII pharmaceutical, another DEA-regulated material, etc.) or some other highly regulated material, a different protocol 240 is followed.

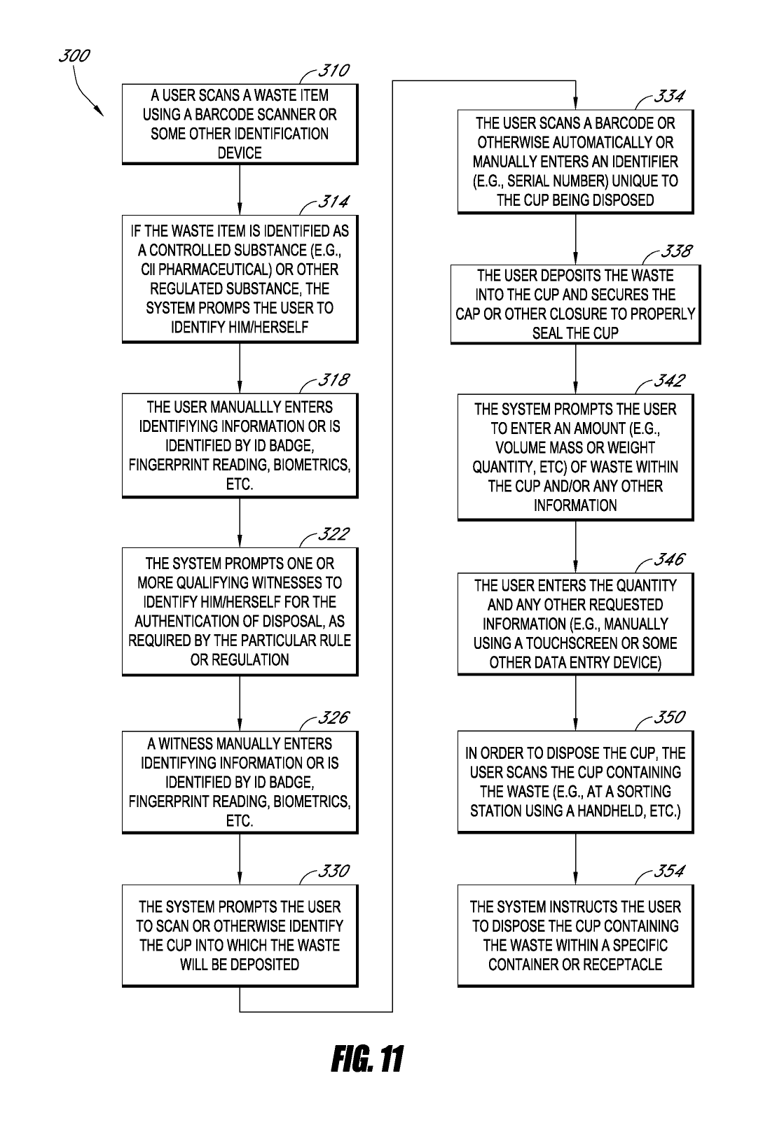

The flowchart 300 of FIG. 11 schematically illustrates a method of disposing a waste item which comprises a controlled substance or other regulated waste, according to one embodiment. As shown, once a waste item has been scanned 310 and identified 314 by the sorting system as a controlled substance (e.g., a CII pharmaceutical) or some other regulated material, the user (e.g., nurse, technician, pharmacist, doctor, etc.) may be asked for his or her identity. As discussed herein, a waste item can be identified automatically by a sorting system (e.g., using a barcode, RFID and/or other identifier) and/or manually (e.g., requiring the user to enter information about the waste item using a keyboard, keypad, touchscreen, other data entry device, etc.). A waste item can be scanned or otherwise identified by a scanner, reader or other identifying device positioned on a sorting and disposal station, on a handheld device, on or near a vessel or cup dispensing system 150′ (FIG. 9) and/or any other device or component that is in data communication with the sorting database.

According to some embodiments, a user provides 318 the requested information about his or her identity to the sorting system in one of several ways. For example, the user can scan his or her identification card or other identifying device through or near a corresponding identification device. In some embodiments, this involves passing a magnetic strip of the identification card through a card reader, passing a barcode of the identification card across a barcode reader, placing the identification card having a RFID device is proximity to a RFID reader, placing a thumb and/or other finger on a fingerprint reader, positioning his or her face in front of a retina or biometrics scanner and/or the like. Alternatively, the user can manually enter his or her name, a username, a password and/or any other information that is required using a touchscreen, keypad, keyboard or any other data entry device. As discussed in greater detail herein with reference to the identification of waste items, such scanners, readers, data entry devices and/or the like can be positioned on or near a sorting station, handheld, vessel, cup dispensing system and/or any other component or location.

In some embodiments, the disposal of a controlled substance or other regulated material necessitates the presence of one or more qualified witnesses to confirm the transfer of such materials into a vessel or cup, to confirm the accuracy of the any information entered into the sorting and disposal system (e.g., the identity of the material, the identity of the user, the volume, weight, mass, quantity or other amount of waste being discarded, the patient in connection with which the controlled substance was used and/or the like). Thus, the sorting and disposal system can be configured to prompt 322 one or more witnesses to provide their identity. As discussed above with reference to the identity of the user, such witnesses can provide 326 their identifying information to the system manually and/or automatically (e.g., using a magnetic strip, barcode, RFID or other identifying features on the identification card, fingerprint, retina or biometrics scanning, manual entry using a touchscreen or other data entry device, etc.).

The user and/or any required witnesses can alternatively identify themselves at an earlier or later stage of the sorting and disposal process. For example, in one embodiment, such individuals provide their identity information to the system at the beginning of the procedure, immediately before the vessel or cup containing the waste is scanned and deposited into a container or receptacle and/or at any other time, as desired or required by a particular rule, regulation or protocol.

As discussed herein with reference to FIGS. 5-9, if an item to be discarded comprises a controlled substance or other regulated material, the waste may first need to be transferred to a vessel or cup 100 or other enclosure. Once the user recognizes or is notified that the waste item comprises a controlled substance, he or she can obtain an unused, sterile vessel or cup. Such vessels or cups 100 can be provided in a dispensing system (FIG. 9), dispensing cabinet, drawer, shelf, tabletop and/or any other location where their sterility can be ensured.

As discussed in greater detail above, the vessels or cups 100 can be supplied or otherwise provided with a barcode, RFID or other unique identifier. In such embodiments, the sorting and disposal system prompts 330 the user to scan the barcode, RFID or other identifier of a cup or vessel or to otherwise identify the vessel or cup into which the controlled substance will be transferred. For example, a user can manually enter a unique alphanumeric code 122 (FIG. 5) associated with a particular vessel or cup 100.

Once the user has identified 334 the vessel or cup to the sorting system, he or she can transfer 338 the waste into the vessel or cup and properly secure the cap or other closure thereto. As discussed above, the lid 130 or other closure can be configured to create a generally water-tight, air-right, leak-proof and/or other type of seal, thereby helping to prevent or reduce the likelihood that any waste positioned within the vessel or cup will leak, evaporate or otherwise escape during any of the sorting, disposal, handling, collection, transfer and/or other steps that follow. According to some arrangements, depositing 338 the waste into the vessel or cup comprises emptying the contents of a vial, ampoule, syringe or other container therein. The controlled substance can include liquids, solids (e.g., granulated, powder or other loose forms, tablets, capsules, etc.), patches, bandages, gels, crèmes, lotions and/or the like. In embodiments where it is generally difficult or impossible to physically separate the controlled substance from its container (e.g., vial, ampoule, covering, sac, packaging, etc.), the controlled substance can be transferred into a vessel or cup along with its container.

The system can be configured to request 342 additional information from a user regarding the waste transferred into a vessel or cup. For example, the system can prompt the user to enter the volume, weight, mass, quantity, size or other measurement related to the amount of waste transferred into the vessel or cup. Relatedly, the system can prompt the user to enter the volume or other amount of controlled substance that is initially included in the vial, ampoule or other container and/or the volume of other amount of controlled substance that is to be immediately used (e.g., administered to a patient). As discussed with reference to FIG. 5, the vessel or cup 100 can be graduated to enable a user to easily and quickly determine 346 the volume of waste contained therein. In other embodiments, a sorting and disposal station and/or another portion of the system includes a scale or other device to help the user to provide 346 the necessary information. In addition, the system can be configured to request additional information regarding the controlled substance or other material being wasted. For example, the user may need to provide the names of the patient and/or doctor in connection with which the specific controlled substance was used.

In other embodiments, a nurse or other user enters the anticipated volume or other amount of controlled substance to be wasted (e.g., residual) before transferring such residual volume into the vessel or cup. For example, if a syringe comprises 10 ml of a controlled substance, but only 8 ml is to be injected into a patient, a nurse can indicate to the system that 2 ml of the controlled substance will be wasted.

After a nurse, other clinician or other user has entered the requested information regarding the waste, the system can be configured to associate a particular vessel or cup with such waste and its various characteristics. Accordingly, when the user scans 350 a barcode of the vessel or cup or otherwise identifies the vessel or cup to a waste sorting and disposal system (e.g., using a RFID device and reader, by manually entering a code, etc.), the system can ascertain the internal contents of the vessel or cup. As a result, the system can be configured to compare this information to the proper database in order to determine the proper container or receptacle into which a vessel or cup should be disposed 354. Alternatively, the vessel or cup can be placed into a receptacle or other container that has been specifically designated to receive controlled substances, without the need to scan the vessel or cup.

In some embodiments, as illustrated in FIGS. 1 and 2, a sorting and disposal station 10, 10A includes one or more containers (not shown) that are configured to receive, either directly or indirectly (e.g., using a vessel or cup), waste comprising controlled substances or other regulated materials. In other arrangements, as illustrated in FIGS. 3 and 4, such waste can be deposited into a receptacle 80′, 80″ that may or may not be physically attached to a main sorting station.

The waste sorting and disposal method for waste comprising controlled substances has been described herein in reference to one particular embodiment. However, one or more aspects of the method and associated devices and systems can be varied, as desired or required. For example, the steps can be re-sequenced. In alternative embodiments, a method can include fewer, additional and/or different steps in accordance with a desired or required procedure or protocol.

A waste sorting and disposal system configured to receive controlled substances, in accordance with the various embodiments disclosed herein, can be used at a pharmacy, hospital, physician's office or other facility as part of a take back program. As a result, information regarding unused controlled substances can be accurately obtained and provided to haulers, treatment facilities and/or the like.

For instance, according to some embodiments, the CS vessels or cups are provided without a barcode or other unique identifier. Thus, a label may need to be added to the outside of a vessel or cup, as discussed with reference to FIG. 9. In other arrangements, cups are color-coded or otherwise distinguished (e.g., by shape, size, other markings, etc.) according to the type of controlled substance waste they are intended to receive. Thus, a user may need to first provide information to the system about a particular waste item (e.g., by scanning its barcode into a scanner of a sorting station, handheld, vessel or cup dispensing system, etc.). Thus, the system can be configured to then instruct the user to transfer the waste item into a particular type of vessel or cup.

Further, in any of the embodiments disclosed herein, the waste sorting and disposal system can be relatively simplified. For example, the need for a nurse or other user to enter his or her identity or other personal information, the need to enter the volume, weight and/or other information about the waste item being discarded and/or other tasks can be eliminated or modified, in accordance with specific needs and requirements of the waste generator (e.g., hospital, pharmacy, other facility, etc.), the waste collector, the waste treatment facility, regulatory and/or enforcement agencies (e.g., EPA, DEA, etc.) and/or the like.

In other arrangements, waste items comprising controlled substances (e.g., CII pharmaceuticals) and/or other regulated materials can be directly deposited into a corresponding container or receptacle 80′, 80″ (FIGS. 3 an 4) without the need to first transfer the waste items to a separate vessel or cup or other enclosure. However, as discussed in greater detail herein, such disposal methods may not be satisfactory to waste haulers or treatment facilities that do not accept comingled waste.

A container or receptacle configured to accept controlled substances can be emptied according to a predetermined time schedule and/or when a particular level within the container or receptacle has been attained. As discussed, such a container or receptacle can include a removable liner. Thus, the following discussion regarding change out procedures is equally applicable to both receptacles and any liners that may be removably placed therein.

According to some embodiments, a special key or code is required to access an interior of the controlled substance container or receptacle, as only certain authorized personnel may be given access to the sensitive materials contained therein. Once a receptacle or liner containing controlled substance waste has been removed, it can be transported and to a secure area. The removed receptacles or liners can be stored in such secure areas until a DEA Registrant hauler or other authorized party or entity arrives to verify their contents and remove them from the hospital, pharmacy, other medical facility and/or other waste generation location. In some embodiments, the liners and/or receptacles comprise barcodes, RFID devices and/or other identifying features so that they can be conveniently tracked and manifested as they are moved through various procedures, including collection, handling, storage, transportation, treatment and/or the like.

In some arrangements, a DEA Registrant hauler or other inspector verifies the contents of the liner or receptacle by scanning or otherwise retrieving data related to one or more CS vessels or cups discarded therein. For example, the DEA Registrant hauler can confirm the accuracy of the type and amount (e.g., volume, weight, quantity, etc.) of waste contained in one or more vessels or cups. According to certain arrangements, one or more vessels or cups are randomly selected and subjected to additional scrutiny to protect against errors, intentional or unintentional diversion and/or the like. For instance, the contents of such random vessel or cup samples can be tested using photospectroscopy and/or any other protocol to confirm the chemical composition, concentration, strength and/or other properties of the waste deposited therein. Accordingly, in one embodiment, the vessels or cups are sized, shaped and otherwise configured for placement into a spectrophotometer or other testing device. In other arrangements, a dipstick or other testing methods can be used to perform the necessary testing or verification. In some embodiments, the vessel or cup comprises a tapered portion, such as a tapered end.

In other embodiments, a DEA Registrant hauler is required to document each and every vessel or cup that contains a controlled substance. Thus, the use of the various devices, systems and methods disclosed herein can facilitate the collection of the necessary information (e.g., type and concentration of waste, volume or amount, etc.) and the generation of any required reports or forms. For example, by scanning the barcodes, reading the RFID devices and/or making use of any identifier associated with the vessels or cups, a DEA Registrant hauler can quickly and accurately obtain detailed information regarding the controlled substances collected from a particular pharmacy, hospital or other waste generation facility.

In one embodiment, once the accuracy of the receptacle or liner contents (e.g., vessels or cups) has been confirmed, one or more regulatory forms, manifests and/or the like can be completed. For example, in order to satisfy federal regulations in the U.S., Form B40 and/or Form 222 can be completed and submitted to the proper governmental agency or authority (e.g., DEA, EPA, appropriate state or local agency, etc.). Advantageously, in embodiments where data and other information regarding the controlled substance waste vessels or cups have been entered and collected during the sorting and disposal methods (as described in greater detail herein), such manifests, other forms and/or other documentation can be automatically completed by communicating with the system's processor or network. As with users that generate and dispose of waste items that comprise controlled substances, inspectors, haulers, treatment personnel and/or other parties that may handle or otherwise come in contact with such waste may also be required to identify themselves and/or provide additional information to further ensure proper custody of the waste and to provide an accurate record of its handling from cradle to grave.

The various waste sorting and disposal devices, systems and methods according to several embodiments disclosed herein can help reduce or eliminate the diversion of controlled substances (e.g., narcotics, other CII pharmaceuticals, other regulated materials, etc.), as the movement of such substances and materials is more accurately tracked within a particular facility (e.g., hospital, pharmacy, clinic, etc.). As a result, the proportion of pharmaceuticals and/or other controlled substances that is wasted (e.g., not used) or otherwise unaccounted can be accurately determined. This can help reduce waste (e.g., by providing valuable insight to hospital, pharmacy or other facility administrators), discourage the theft or unintentional diversion of controlled substances, discourage counterfeiting of pharmaceuticals (e.g., filling of empty vials with placebos, saline, etc.) and/or provide additional benefits. This may be particularly important for experimental controlled substances and other materials that tend to be very expensive.

Because the volume or other amount of a wasted pharmaceutical is measured and recorded by the sorting and disposal system, the portion (e.g., volume) of such a pharmaceutical that is actually administered to a patient can be accurately or approximately calculated. Thus, the detailed information that is collected regarding the handling and use of controlled and/or other regulated substances within a hospital, other healthcare facility, pharmacy and/or the like, including both the tracking of the actual substances and the tracking of nurses, technicians, doctors and other personnel that have access to such substances, can help make such personnel more accountable for intentional and unintentional diversions.

In addition, such enhanced sorting and disposal devices, systems and methods can help satisfy the various environmental, drug-enforcement and other regulatory laws, regulations, goals and other requirements which currently exist and which are likely to be implemented in the future. For example, the various embodiments disclosed herein help improve the accuracy of cradle-to-grave tracking of controlled substances and/or other regulated materials. This can assist in advantageously reducing waste and promoting resource conversation.

### EXAMPLES

The following non-limiting examples illustrate embodiments of the disclosure presented herein and are not intended in any way to limit the disclosure provided herein.

### Example No. 1

In one embodiment, a nurse obtains a syringe or other container having a controlled substance (e.g., morphine) that will be injected into a patient. In order to obtain information regarding the controlled substance (e.g., name, concentration, batch number, etc.), the nurse can use a scanner (e.g., located on a sorting and disposal station, a handheld or any other location) to scan the barcode of the syringe. Once the sorting and disposal system recognizes that the syringe comprises a controlled substance, it can prompt the nurse to enter certain identifying information, such as, for example, his or her name. In some embodiments, the nurse slides his or her identification card through a reader, passes his or her card in the vicinity of a RFID reader or performs any other action that allows the system to automatically recognize his or her identity. In addition, the system can optionally require that one or more authorized persons witness the nurse while he or she administers the controlled substance and/or wastes a particular volume of the controlled substance. Thus, the witnesses identify themselves to the system either automatically or manually.

For purposes of this example, the syringe contains 10 ml of the controlled substance. However, the patient is set to receive only 8 ml of the controlled substance. Accordingly, the residual 2 ml of the controlled substance will need to be wasted. According to one embodiment, the nurse obtains a sterilized bar-coded vial or cup, deposits the residual 2 ml of the controlled substance into it and injects 8 ml into the patient. Further, the nurse seals the vessel or cup, which now should contain 2 ml of the controlled substance, using a lid or other closure. Next, the nurse scans the barcode or other identifier placed on the vessel or cup using a scanner of the sorting and disposal system. The system receives the information and, in response, prompts the nurse to enter the volume, weight, quantity or other amount of the controlled substance that has been placed into the vessel or cup. Alternatively, the system may have required the nurse to enter the anticipated amount of residual volume prior to the nurse placing the 2 ml into the vessel or cup. After the nurse enters the volume of residual controlled substance that has been placed into the vessel, he or she disposes the vessel into a container or receptacle of the waste sorting and disposal station that is configured to receive controlled substance waste.

An authorized hauler can then access the vessels that have been deposited into the interior of the controlled substance container or receptacle. The hauler can scan each vessel to accurately determine the types, concentrations, volumes or other amounts and/or other details regarding the various controlled substances present within the controlled substances container or receptacle. In order to ensure the accuracy of the information entered by the nurse and other personnel, random vessels can be selected for testing.

### Example No. 2

In some embodiments, a nurse obtains a vial having a controlled substance (e.g., morphine) that will be injected into a patient. The nurse manually enters the information about the controlled substance contained with the vial into the sorting and disposal system using a touchscreen or some other data input device. Once the sorting and disposal system recognizes that the syringe comprises a controlled substance, it will prompt the nurse to enter certain identifying information, such as, for example, his or her name. The nurse manually enters the requested identifying information. In addition, the system optionally requires that an authorized person witness the nurse while he or she administers the controlled substance and/or wastes a particular volume of the controlled substance in accordance with the prescribed treatment. Thus, the witness automatically or manually identifies himself or herself to the system.

For purposes of this example, the syringe contains 10 ml of the controlled substance. However, the patient is set to receive only 5 ml of the controlled substance. Accordingly, the residual 5 ml of the controlled substance will need to be wasted. According to one embodiment, the nurse obtains a sterilized vial or cup that does not include a barcode or other identifying information. The nurse then transfers 5 ml of the controlled substance into the vessel or cup, and administers the remaining 5 ml to the patient. After the nurse has sealed the vessel or cup using a lid or other closure, he or she can enter the volume or other amount of the controlled substance that was wasted into the sorting and disposal system (e.g., using a touchscreen or other data entry device). The system receives the information and prints a customized label that is to be placed on the vial or cup. The nurse then deposits the labeled vial or cup into a container or receptacle of the waste sorting and disposal station that is configured to receive controlled substance waste.

Although certain embodiments and examples have been described herein, it will be understood by those skilled in the art that many aspects of the methods and devices shown and described in the present disclosure may be differently combined and/or modified to form still further embodiments. Additionally, it will be recognized that the methods described herein may be practiced using any device suitable for performing the recited steps. Moreover, the methods steps need not be practiced in any given order in some embodiments. Such alternative embodiments and/or uses of the methods and devices described above and obvious modifications and equivalents thereof are intended to be within the scope of the present disclosure. Thus, it is intended that the scope of the present inventions should not be limited by the particular embodiments described above, but should be determined by a fair reading of the claims that follow.

What is claimed is:

1. A method for tracking a controlled substance before and after such controlled substance is administered to a patient, the method comprising:
obtaining information regarding a controlled substance to be administered to a patient and a corresponding residual volume of the controlled substance;
wherein the residual volume of the controlled substance comprises an amount of the controlled substance that is not administered to the patient and that is designated for disposal;
obtaining information from a spent drug container, said spent drug container configured to receive the residual volume of the controlled substance;
wherein the spent drug container comprises a closure member to secure the residual volume of the controlled substrate within the spent drug container;
electronically accessing a database of a waste sorting system, said database comprising waste item classification information;
wherein the waste sorting system comprises a plurality of waste container compartments, each of said waste container compartments configured to receive a removable waste container;
wherein a movable lid is coupled to at least one removable waste container of the waste sorting system;
wherein each of the removable waste containers is associated with at least one of a plurality of waste categories, wherein each of the movable lids is configured to be selectively moved between an open position and a closed position, said movable lids configured to selectively expose an opening in the corresponding removable waste containers when in an open position;
wherein at least one of the removable waste containers of the waste sorting system is configured to receive controlled substances;
electronically assigning the spent drug container comprising the residual volume of the controlled substance to at least one waste category based at least in part on the obtained information and the waste item classification information;
providing access to an interior of the removable waste container associated with said waste category to permit disposal of the spent drug container and the controlled substance positioned therein;
prompting a user to enter information regarding the quantity of the residual controlled substance; and
comparing the quantity of the residual volume of the controlled substance within the spent drug container with a quantity of the controlled substance prior to administration to the patient and a quantity of the controlled substance intended to be administered to the patient, thereby tracking the controlled substance before and after administration to the patient.

2. The method of claim 1, wherein the spent drug container comprises a vessel.

3. The method of claim 2, wherein the vessel comprises a cup adapted to receive the residual volume of the controlled substance that was previously contained in a vial, bottle or syringe.

4. The method of claim 1, wherein the spent drug container comprises at least one of a vial, bottle, a syringe and an intravenous (IV) bag.

5. The method of claim 1, wherein obtaining information regarding a controlled substance or from the spent drug container comprises scanning a barcode associated with the controlled substance or the spent drug container via a barcode reader.

6. The method of claim 1, wherein obtaining information regarding a controlled substance or from the spent drug container comprises prompting a user to input data in a user input device.

7. The method of claim 6, wherein the user input device comprises a touchscreen or keyboard.

8. The method of claim 6, wherein the user input device comprises a handheld.

9. The method of claim 1, wherein each of the removable waste containers comprises at least one opening through which items are selectively placed within the removable waste containers and a machine readable identification key.

10. The method of claim 9, wherein the waste sorting system is configured to read the machine readable identification key to determine the waste category associated with the corresponding removable waste container via a key reader.

11. The method of claim 1, further comprising calculating a quantity of the controlled substance that was actually administered to the patient by comparing the residual volume of the controlled substance to a quantity of the controlled substance prior to administration of said controlled substance to the patient.

12. The method of claim 1, further comprising reporting to a user the quantity of the controlled substance that was intended to be administered to the patient.

13. The method of claim 1, further comprising generating a manifest containing information relating to information about the residual volume of the controlled substance disposed within the waste sorting system.

14. The method of claim 1, wherein the waste item classification information comprises classification information based on environmental or drug enforcement regulations contained in a database.

15. The method of claim 1, wherein the moveable lids are configured to be manually closed upon disposal of the spent drug container.

16. The method of claim 1, wherein at least one of the moveable lids is configured to be automatically closed upon disposal of the spent drug container within the corresponding removable waste container.

17. A sorting system for sorting and tracking a controlled substance before and after administration to a patient, the system comprising:
a plurality of waste containers, at least one of said waste containers configured to receive waste comprising a controlled substance,
wherein each of the waste containers comprises an opening;
a movable lid coupled to at least one of the waste containers;
wherein each of the waste containers is associated with at least one of a plurality of waste categories;
wherein each of the lids is configured to move between an open position and a closed position to selectively provide and close access to the corresponding waste container;
an input device configured to receive information associated with a spent drug container, wherein said spent drug container comprises a residual volume of a controlled substance;
wherein the residual volume of the controlled substance is the amount of a controlled substance that is designated for disposal; and
a control system configured to compare the quantity of the residual volume of the controlled substance with a quantity of the controlled substance prior to administration to a patient, thereby tracking the controlled substance before and after administration to a patient;
wherein the control system is further configured to assign the residual volume of the controlled substance to at least one waste category based at least in part on inputted information and waste item classification information contained in a database, said control system configured to provide access to at least one of the waste containers for depositing the spent drug container therein; and
wherein the control system is further configured to prevent access to an interior of the waste container after the spent drug container is disposed therein.

18. The sorting system of claim 17, wherein the spent drug container comprises a cup.

19. The sorting system of claim 18, wherein the cup serves as a vessel for receiving a residual volume of a controlled substance previously contained in a vial, bottle or syringe.

20. The sorting system of claim 17, wherein the spent drug container comprises a vial, bottle, a syringe, or an intravenous (IV) bag.

21. The sorting system of claim 17, further comprising a printer for generating a manifest containing information regarding the quantity of the controlled substances deposited within the waste containers of the sorting system.

22. The sorting system of claim 17, wherein the waste item classification information comprises classification information based at least in part, on environmental or drug enforcement regulations contained in a database.

23. The sorting system of claim 17, wherein at least one of the lids is configured to be manually closed.

24. The sorting system of claim 17, wherein at least one of the waste containers does not comprise a movable lid.

25. The sorting system of claim 17, wherein at least one of the waste containers comprises a slot or other opening, said slot or other opening configured to prevent access to waste items situated within an interior of the waste container.

26. The sorting system of claim 17, wherein the input device is configured to obtain a volume or other quantity of the controlled substance to be administered to a patient.

27. The sorting system of claim 17, wherein the input device comprises a touch screen or keyboard.

28. The sorting system of claim 17, wherein the input device comprises a barcode reader.

29. A method of sorting controlled substances, comprising:
scanning a bar-coded drug container, wherein said bar-coded drug container comprises a drug waste;
accessing a database to assign said drug waste to a waste category;
identifying said drug waste as a controlled substance based on said waste category;
prompting a user to enter said user's identification;
prompting a witness to enter said witness's identification;
scanning a bar-coded vessel, wherein said vessel is configured to receive a residual portion of the controlled substance from the bar-coded drug container,
wherein said residual controlled substance is the amount of controlled substance that is designated for disposal;
prompting the user to enter the quantity of the residual controlled substance placed in the vessel after said user has transferred the controlled substance from the drug container to the vessel; and
prompting the user to dispose of said vessel in the appropriate waste container.

30. A method of sorting controlled substances, comprising:
scanning a bar-coded drug container, wherein said bar-coded drug container comprises a drug waste;
accessing a database to assign said drug waste to a waste category;
identifying said drug waste as a controlled substance based on said waste category;
obtaining a user's identification information;
obtaining a witness's identification information;
scanning a bar-coded vessel, wherein said vessel is configured to receive a residual portion of the controlled substance from the bar-coded drug container,
wherein said residual controlled substance is the amount of controlled substance that is designated for disposal;
prompting the user to enter the quantity of the residual controlled substance that should be placed in the vessel after said user has transferred the controlled substance from the drug container to the vessel; and
prompting the user to dispose of said vessel in the appropriate waste container.
